(19) United States
(12) Patent Application Publication
(10) Pub. No.: US 2018/0129385 A1
(43) Pub. Date: May 10, 2018

(54) Automated Agent for Content Interaction

(71) Applicant: Microsoft Technology Licensing, LLC, Redmond, WA (US)

(72) Inventors: Dan Blumenfeld, Los Altos, CA (US); Vijay Chandrasekaran, Sunnyvale, CA (US)

(73) Assignee: Microsoft Technology Licensing, LLC, Redmond, WA (US)

(21) Appl. No.: 15/344,271

(22) Filed: Nov. 4, 2016

(51) Int. Cl. G06F 3/0484; G06F 3/0488; G06F 17/30; G06Q 30/06

(52) U.S. Cl. CPC G06F 3/0484; G06F 3/04883; G06F 17/30864; G06F 3/0482; G06F 17/3084; G06Q 30/0641; G06F 17/3082

(57) ABSTRACT

Techniques for automated agent for content interaction are described. According to various implementations, a user can access content, such as video content, and can initiate an interactivity experience to explore the content. The interactivity experience, for instance, represents a chat session with an automated agent, such as a bot. Depending on a context of the content, the automated agent can present different interactivity options for exploring the content.

### BACKGROUND

Today's online environment provides access to an enormous amount of content. Enabling users to interact with content and obtain information of personal interest about content presents a number of challenges, both from a system resources and a user interaction perspectives.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for automated agent for content interaction are described. According to various implementations, a user can access content, such as video content, and can initiate an interactivity experience to explore the content. The interactivity experience, for instance, represents a chat session with an automated agent, such as a bot. Depending on a context of the content, the automated agent can present different interactivity options for exploring the content.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more implementations.

FIG. 2 depicts an example implementation scenario for navigating content in accordance with one or more implementations.

FIG. 3 depicts an example implementation scenario for navigating content in accordance with one or more implementations.

FIG. 4 depicts an example implementation scenario for exploring content in accordance with one or more implementations.

FIG. 5 depicts an example implementation scenario for interacting with content in accordance with one or more implementations.

FIG. 6 depicts an example implementation scenario for interacting with content in accordance with one or more implementations.

FIG. 7 is a flow diagram of an example method for enabling interaction with content in accordance with one or more implementations.

FIG. 8 is a flow diagram of an example method for enabling interaction with content in accordance with one or more implementations.

FIG. 9 illustrates an example system and computing device such as described with reference to FIG. 1, which are configured to implement implementations of techniques described herein.

### DETAILED DESCRIPTION

Techniques for automated agent for content interaction are described. According to various implementations, a user can access content, such as video content, and can initiate an interactivity experience to explore the content. The interactivity experience, for instance, represents a chat session with an automated agent, such as a bot. Depending on a context of the content, the automated agent can present different interactivity options for exploring the content.

Accordingly, techniques described herein for automated agent for content interaction provide efficient ways identifying different contexts for content, and also for searching for and discovering information pertaining to the contexts. Thus, system resources such as processor time, network bandwidth, and server resources are conserved in comparison with traditional search algorithms by reducing a number and complexity of searches required to enable a user to obtain relevant information about content. Further, user engagement and satisfaction with a content experience are increased in comparison with traditional search algorithms by reducing the number of user interactions required to discover information of interest.

In the following discussion, an example environment is first described that is operable to employ techniques described herein. Next, some example implementation scenarios are presented in accordance with one or more implementations. Following this, some example procedures are discussed in accordance with one or more implementations. Finally, an example system and device that are operable to employ techniques discussed herein in accordance with one or more implementations.

Having presented an overview of example implementations in accordance with one or more implementations, consider now an example environment in which example implementations may by employed.

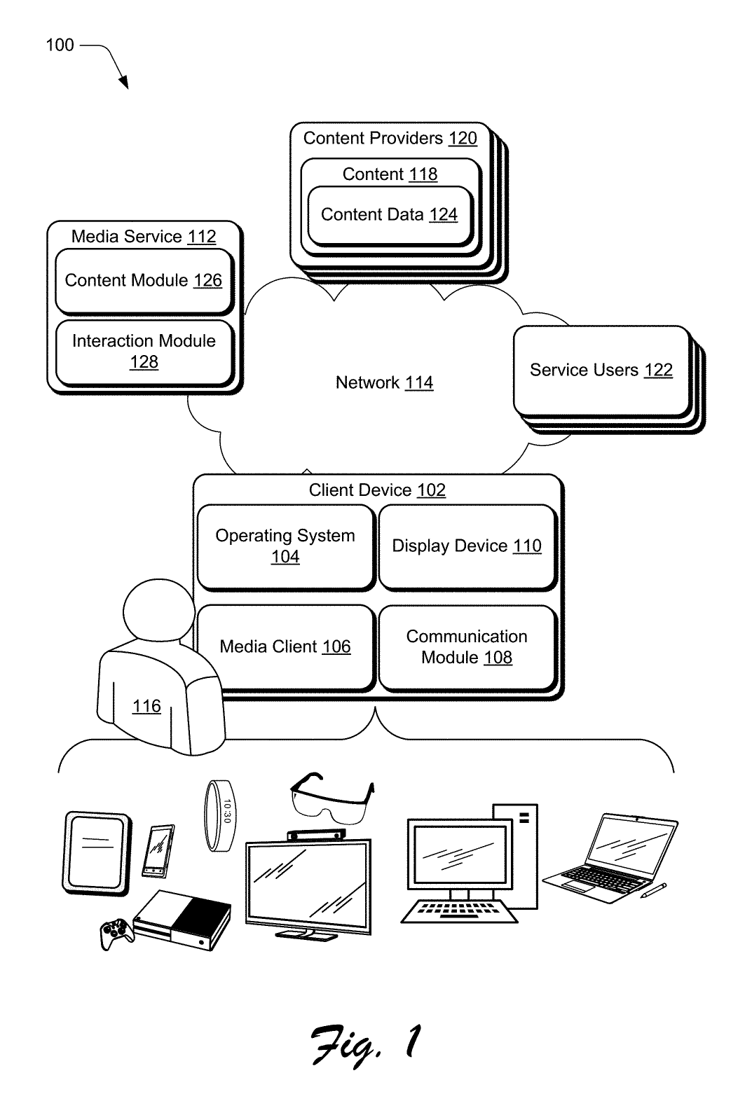

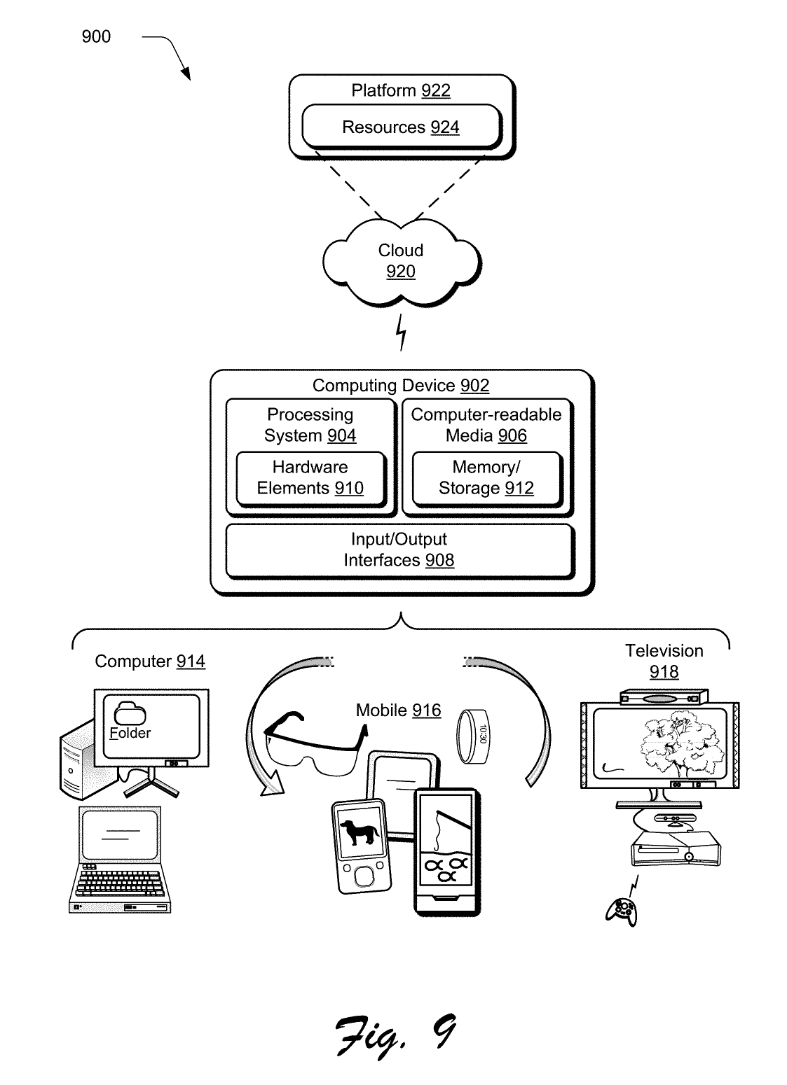

FIG. 1 is an illustration of an environment 100 in an example implementation that is operable to employ techniques for automated agent for content interaction discussed herein. Environment 100 includes a client device 102 which can be implemented as any suitable device such as, by way of example and not limitation, a smartphone, a tablet computer, a portable computer (e.g., a laptop), a desktop computer, a wearable device, a mixed reality device, combinations thereof, and so forth. Thus, the client device 102 may range from a system with significant processing power, to a lightweight device with minimal processing power. One of a variety of different examples of a client device 102 is shown and described below in FIG. 9.

The client device 102 includes a variety of different functionalities that enable various activities and tasks to be performed. For instance, the client device 102 includes an operating system 104, a media client 106, a communication module 108, and a display device 110. Generally, the operating system 104 is representative of functionality for abstracting various system components of the client device 102, such as hardware, kernel-level modules and services, and so forth.

The media client 106 represents functionality for accessing a media service 112 via a network 114. Generally, the media service 112 represents a network-based service that is remote from the client device 102 and that enables a user 116 of the client device 102 to access content 118 provided by content providers 120. Examples of the media service 112 include a chat service, a collaboration service, a meeting service, a social media service, a content sharing service, and so forth. In at least some implementations, the user 116 and other service users 122 interact via the media service 112 to communicate via various modalities (e.g., text chat, audio, video, and so forth), exchange content, engage in business transactions, and so on.

According to various implementations, the media client 106 may be installed locally on the client device 102 to be executed via a local runtime environment, and/or may represent a portal to remote functionality hosted by the media service 112. Thus, the media client 106 may take a variety of forms, such as locally-executed code, a portal to remotely hosted services, and so forth.

The content providers 120 are generally representative of entities that generate and/or publish content 118 that is accessible over the network 114, such as via the Internet. Examples of the content providers 120 include enterprise entities such as a news service, an entertainment service, a social media service, a website, and so forth. The content providers 120 may include other types of entities, such as educational services, government services, public interest services, and so forth. The content 118 can generally take a variety of forms, such as images, video, audio, text, multimedia content, and so forth.

The content 118 further includes content data 124 that describes various attributes of the content 118. In at least some implementations, the content data 124 includes data (e.g., metadata) the includes various context information for the content 118. Each instance of the content 118, for example, includes a different respective instance of the content data 124. As further described below, the content data 124 can be accessed to enable various types of interactivity with the content 118.

The communication module 108 is representative of functionality for enabling the client device 102 to communication over wired and/or wireless connections to the network 114. For instance, the communication module 108 represents hardware and logic for communication via a variety of different wired and/or wireless technologies and protocols.

As further depicted in the environment 100, the media service 112 includes a content module 126 and an interaction module 128. The content module 126 is representative of functionality to enable the media service 112 to obtain the content 118 from the content providers 120 and cause the content 118 to be presented by the media client 106 on the client device 102. The content module 126, for instance, represents an interface to the media service 112 that the content providers 120 can leverage to publish the content 118 to the media service 112.

The interaction module 128 generally represents functionality to enable the user 116 to interact with content 118 presented by the media client 106 via the media service 112. In at least some implementations, the interaction module 128 may be implemented as an automated agent (e.g., a bot, chat bot, and so forth) that is executed by the media service 112 to perform various automated tasks. As further detailed below, the user 116 can interact with the interaction module 128 via the media client 106 to enable the user 116 to explore the content 118 and obtain information about the content 118. According to one or more implementations, interaction between the user 116 and the interaction module 128 can simulate a human conversation, such as a chat conversation. The interaction module 128, for instance, can access content data 124 for a particular instance of the content 118 to enable the interaction module 128 to present an interactivity experience that enables the user 116 to interact with the instance of content 118 in various ways.

The display device 110 generally represents functionality for visual output for the client device 102. Additionally, the display device 110 represents functionality for receiving various types of input, such as touch input, pen input, and so forth. The network 114 may be implemented in various ways, such as a wired network, a wireless network, and combinations thereof. In at least some implementations, the network 114 represents the Internet.

Having described an example environment in which the techniques described herein may operate, consider now a discussion of some example implementation scenarios in accordance with one or more implementations.

This section describes some example implementation scenarios for automated agent for content interaction in accordance with one or more implementations. The implementation scenarios may be implemented in the environment 100 described above, the system 900 of FIG. 9, and/or any other suitable environment. The implementation scenarios and procedures, for example, describe example operations of the client device 102 and/or the media service 112. While the implementation scenarios are discussed with reference to a particular application (e.g., the media client 106), it is to be appreciated that techniques for automated agent for content interaction discussed herein are applicable across a variety of different applications, services, and environments.

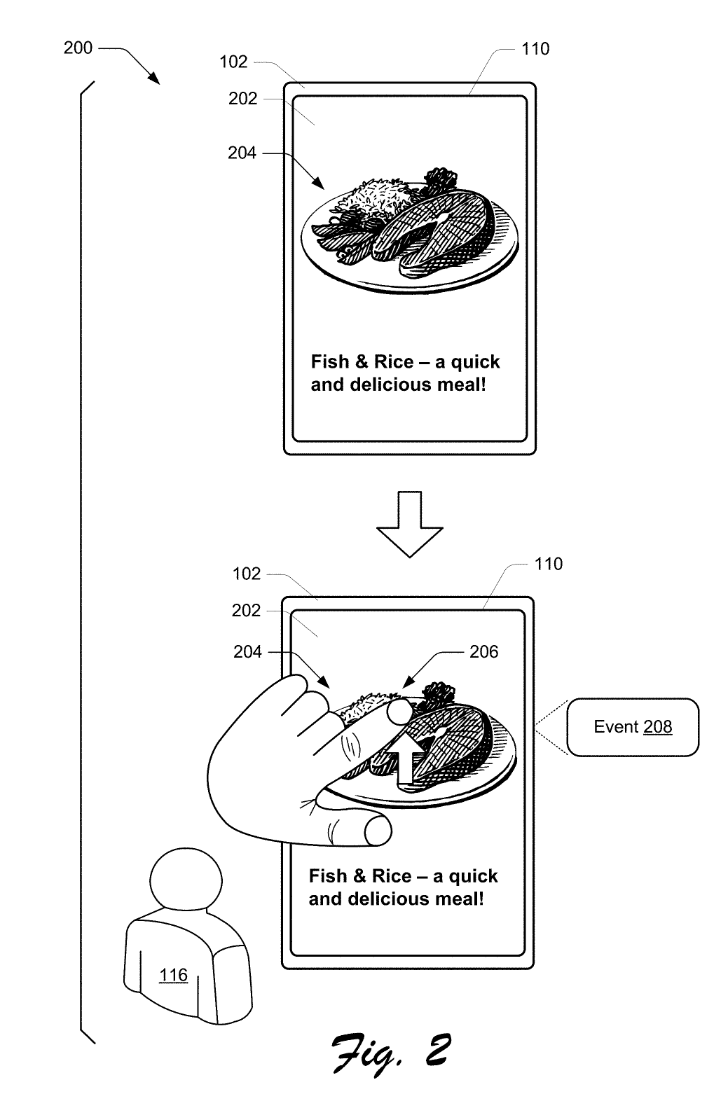

FIG. 2 depicts an example implementation scenario 200 for navigating content in accordance with one or more implementations. The scenario 200 includes an interaction GUI 202 which is presented by the media client 106 and displayed on the display device 110 of the client device 102. The interaction GUI 202, for instance, is generated by the media client 106 and/or the media service 112. In the upper portion of the scenario 200, the interaction GUI 202 includes a preview 204. Generally, the preview 204 represents a portal to content. The preview 204 may be implemented in various ways, such as a static image, text, a short video, combinations thereof, and so on. In this particular implementation, the preview 204 includes an image of a meal overlaid with some text describing the meal.

In at least some implementations, the preview 204 represents an instance of the content 118 provided by one of the content providers 120. The user 116, for instance, navigates the media client 106 to the preview 204, such by selecting to view content from one of the content providers 120.

Proceeding to the lower portion of the scenario 200, the user 116 provides input to the preview 204. The user 116, for instance, applies a swipe gesture 206 to the display device 110 on top of the preview 204. According to implementations for automated agent for content interaction discussed herein, the gesture 206 invokes a transition event 208 which causes a change in user experience. As detailed below, for instance, the transition event 208 causes a transition from the preview 204 two an instance of content represented by the preview 204.

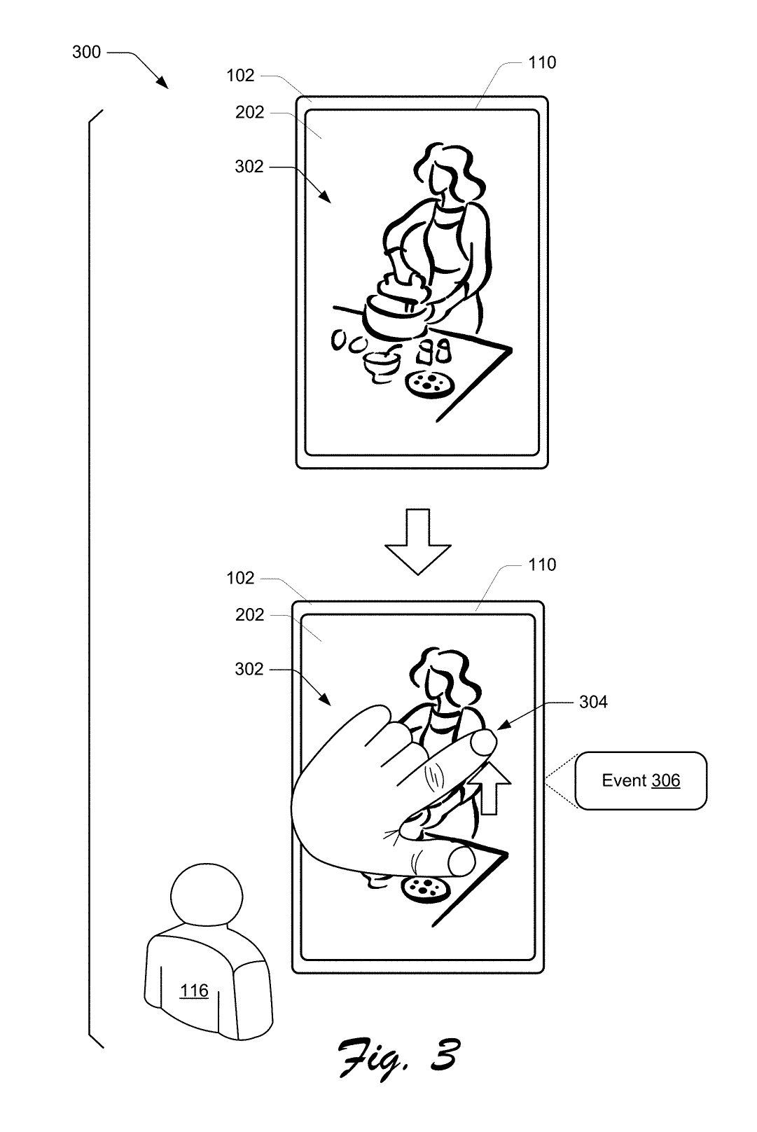

FIG. 3 depicts an example implementation scenario 300 for navigating content in accordance with one or more implementations. The scenario 300, for example, represents a continuation of the scenario 200.

In the upper portion of the scenario 300, the preview 204 is replaced in the interaction GUI 202 with content 302. The media client 106, for instance, detects the transition event 208 and communicates with the media service 112 to obtain the content 302. The media service 112 may obtain the content 302 in various ways, such as from a local storage location and/or via a query to one of the content providers 120. In this particular example, the content 302 is a cooking video that demonstrates a chef cooking the meal represented in the preview 204.

Proceeding to the lower portion of the scenario 300, the user 116 applies a swipe gesture 304 on the display device 110 and on top of the content 302 while the content 302 is presented. The gesture 304, for instance, is applied to the display device 110 while the video is in progress. According to techniques for automated agent for content interaction discussed herein, the gesture 304 applied to the content 302 invokes an interaction event 306. Generally, the interaction event 306 enables the user 116 to explore the content 302 and obtain information about the content 302.

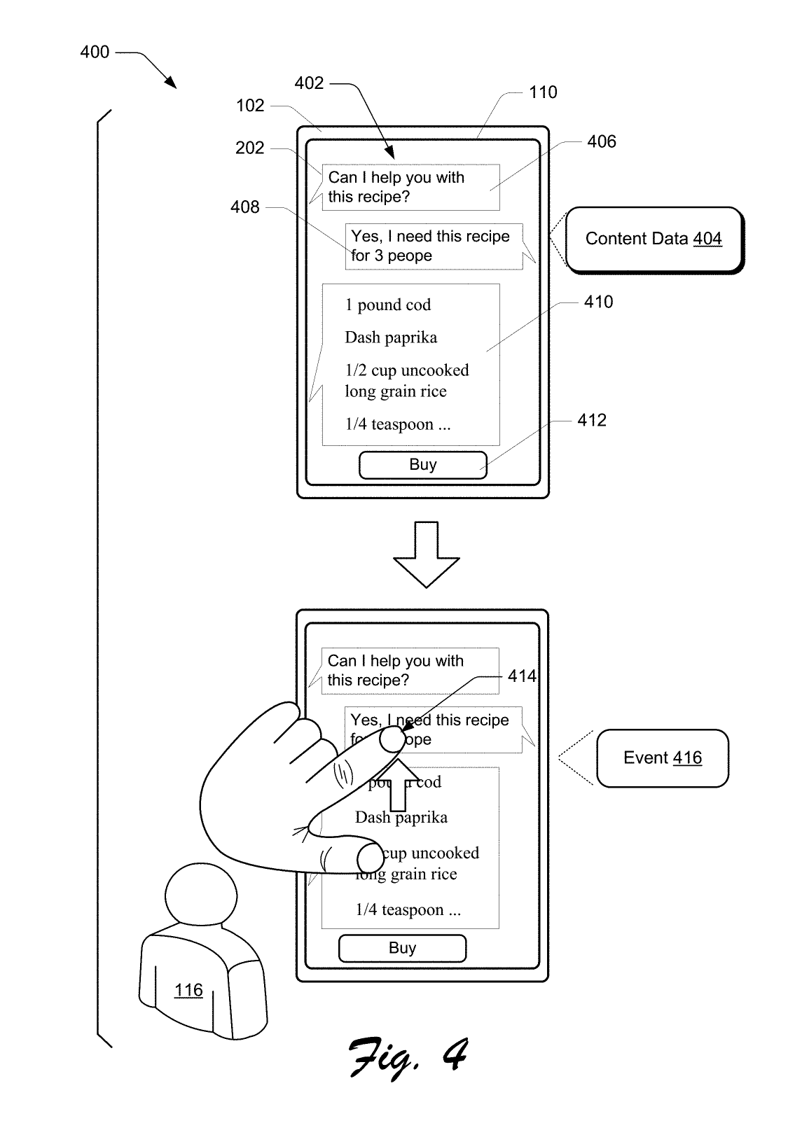

FIG. 4 depicts an example implementation scenario 400 for exploring content in accordance with one or more implementations. The scenario 400, for example, represents a continuation of the scenarios 200, 300.

In the upper portion of the scenario 400, an interaction experience 402 is initiated in response to the interaction event 306. The content 302, for instance, is overlaid or replaced in the interaction GUI 202 with the interaction experience 402. Generally, the interaction experience 402 represents an interaction between the user 116 and the interaction module 128.

As part of the interaction experience 402, the interaction module 128 obtains content data 404 that pertains to the content 302. The content data 404, for instance, represents an instance of the content data 124 and includes context information for the content 302. According to various implementations, the content data 404 includes context data about the content 302 that enables the interaction module 128 to initiate and participate in the interaction experience 402 with the user 116. The content data 404, instance, represents a script that can be leveraged by the interaction module 128 to engage in a chat conversation with the user 116. For example, the content data 404 includes human-readable words and/or phrases that are correlated to the content 302 and that can be selected and output by the interaction module 128 as part of the interaction experience 402. In at least some implementations, the content data 404 includes different context-based queries that each apply to a different context of multiple different contexts for the content 302, and that can be presented to the user 116 dependent on a current context of the content 302.

In this particular example, the content data 404 is indexed to correspond to different portions of the content 302. For instance, different portions of the content data 404 have different timestamps that correspond to different playback times for the content 302. As an example, a first portion of the content data 404 may be linked to a first 30 seconds of the content 302, a second portion of the content data 404 may be linked to a second 30 seconds of the content 302, and so forth. Thus, in at least some implementations, a portion of the content data 404 that is used by the interaction module 128 as part of the interaction experience 402 depends on a playback time (e.g., a context) of the content 302 when the interaction event 306 was invoked.

As part of the interaction experience 402, the interaction module 128 presents a query 406 that asks whether the user 116 needs particular information. Since the interaction module 128 knows based on the content data 404 that the content 302 was showing a particular meal being cooked when the user invoked the interaction experience 402, the query 406 asks whether the user 116 wants help with a recipe for that particular meal. Interaction by the interaction module 128, for instance, is dependent at least in part on an activity (e.g., cooking) depicted in the content 302 when the user applies the gesture 304 discussed with reference to the scenario 300.

Accordingly, the user 116 inputs a request 408 that requests the recipe for three people, and the interaction module 128 recognizes the request 408 as a request for ingredients for the recipe for three people. Accordingly, the interaction module 128 searches the content data 404 data for data pertaining to the recipe as arranged for three portions, and outputs a response 410 that lists ingredients for the recipe as arranged for three people. The content data 404, for example, includes data that describes ingredients for the recipe and relative portions for the ingredients such that the interaction module 128 is able to use the data to adjust portions for the recipe.

Notice that the interaction experience 402 includes an action control 412 that enables the user 116 to perform an action pertaining to the response 410. In this particular example, the action control 412 is selectable to cause an automated order of the ingredients included as part of the response 410. For instance, in response to selection of the action control 412, the interaction module 128 initiates an automated transaction that causes ingredients listed in the response 410 to be ordered, charged to the user 116, and delivered to the user 116.

Proceeding to the lower portion of the scenario 400, the user 116 applies a swipe gesture 414 on the display device 110 and while the interaction experience 402 is active. The gesture 414, for instance, is applied to the display device 110 while the interaction experience 402 is active. According to techniques for automated agent for content interaction discussed herein, the gesture 414 invokes a transition event 416 that causes a transition from the interaction experience 402 back to the content 302. For instance, the transition event 416 causes the content 302 to resume playback from a point at which the content 302 was paused to present the interaction experience 402.

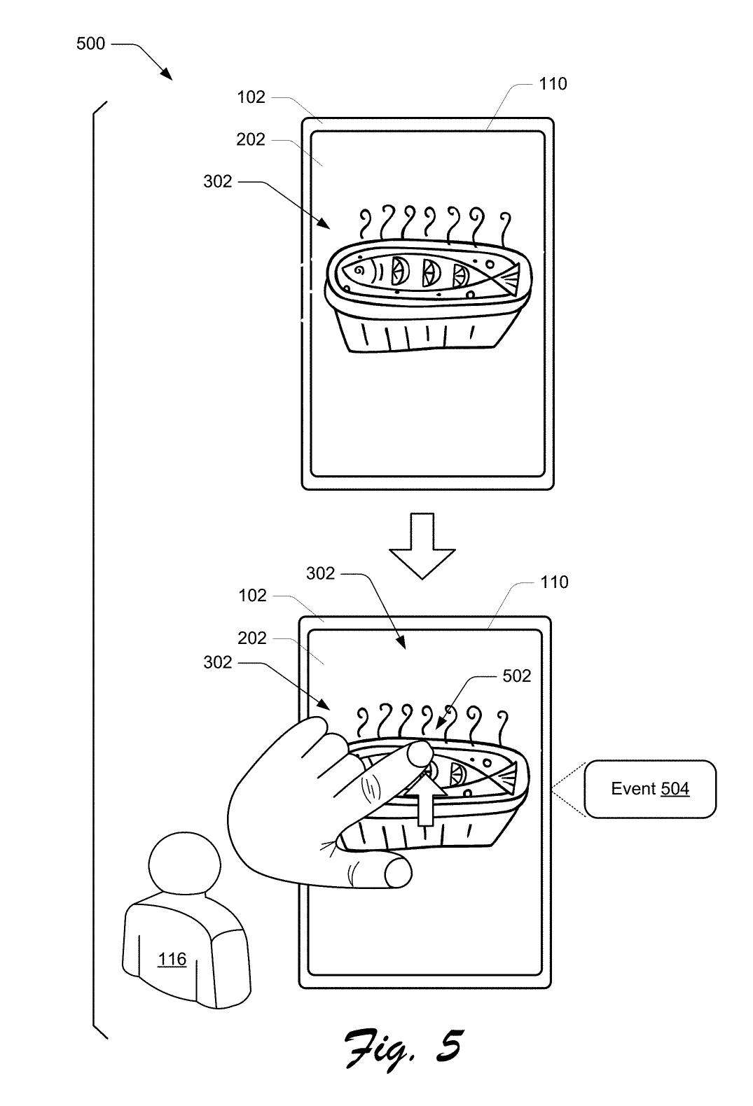

FIG. 5 depicts an example implementation scenario 500 for interacting with content in accordance with one or more implementations. The scenario 500, for example, represents a continuation of the scenarios 200-400.

In the upper portion of the scenario 500, and in response to the transition event 416, the interaction GUI 202 transitions from the interaction experience 402 back to the content 302. The interaction module 128, for instance, detects the transition event 416 and notifies the media service 112 to resume playback of the content 302 via the media client 106. For example, the media client 106 resumes playback of the content 302 from a point at which the playback was paused to present the interaction experience 402.

Proceeding to the lower portion of the scenario 500 and while playback of the content 302 continues, the user 116 applies a gesture 502 to the display device 110 over the content 302. According to techniques for automated agent for content interaction discussed herein, the gesture 502 applied to the content 302 invokes an interaction event 504. Generally, the interaction event 504 causes a further interaction experience for the content 302 to be initiated.

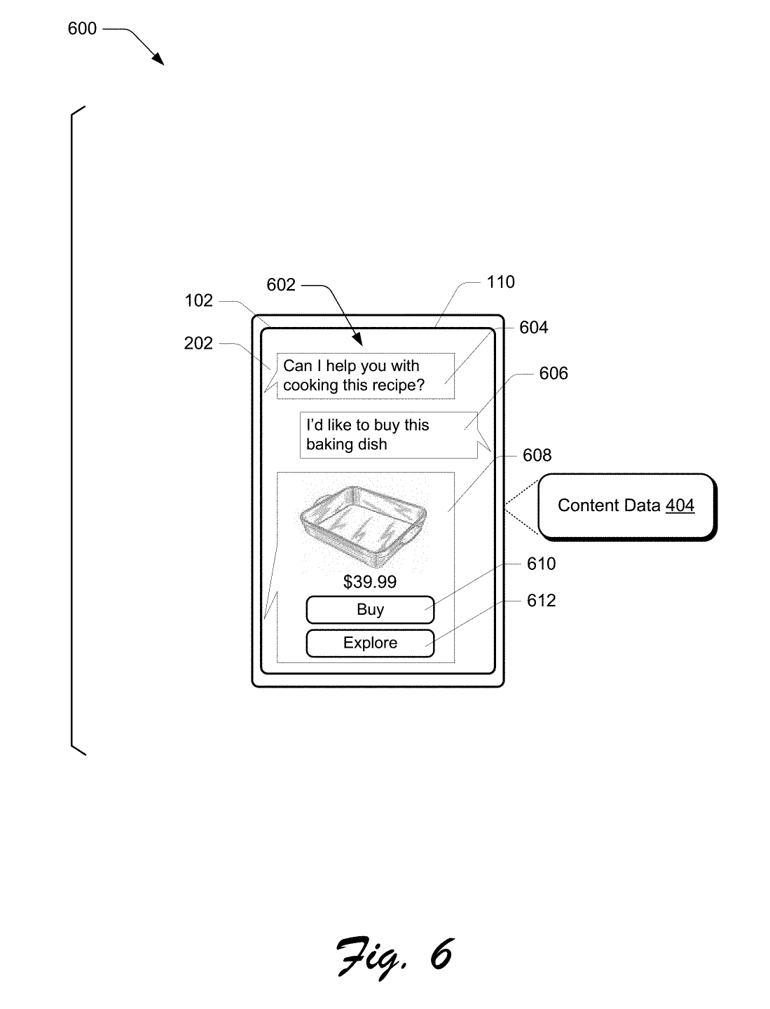

FIG. 6 depicts an example implementation scenario 600 for interacting with content in accordance with one or more implementations. The scenario 600, for example, represents a continuation of the scenarios 200-500.

In the upper portion of the scenario 600, an interaction experience 602 is initiated in response to the interaction event 504. The content 302, for instance, is overlaid or replaced in the interaction GUI 202 with the interaction experience 602. Generally, the interaction experience 602 represents an interaction between the user 116 and the interaction module 128.

As part of the interaction experience 602, the interaction module 128 accesses the content data 404 to interact with the user 116. Since playback of the content 302 has proceeded past a point in which the previous interaction experience 402 was invoked, a context in which the interaction experience 602 is invoked is different than a context in which the interaction experience 402 was invoked. For instance, based on the content data 404, the interaction module 128 determines that the content 302 currently includes a recipe being cooked. Accordingly, the interaction module 128 presents a query 604 that asks whether the user wants help with cooking this recipe. In response, the user inputs a request 606 that indicates that the user wants to purchase a baking dish currently included as part of the content 302. The interaction module 128 recognizes the request 606 as a request to purchase an item depicted in the content 302 (e.g., the baking dish), and thus retrieves information from the content data 404 pertaining to the baking dish. The content data 404, for instance, includes a materials list for cooking the recipe depicted in the content 302.

Accordingly, the interaction module 128 outputs a response 608 that depicts the baking dish and information about the baking dish along with an action control 610 that is selectable to initiate a purchase transaction for purchasing the baking dish. For instance, in response to selection of the action control 610, the interaction module 128 initiates an automated transaction that causes the baking dish to be ordered, charged to the user 116, and delivered to the user 116.

The response 608 also includes an explore control 612 that is selectable to obtain additional information about the baking dish and/or other materials involved in cooking the recipe. For instance, selecting the explore control 612 causes additional information about the baking dish to be retrieved and displayed on the display device 110. In at least some implementations, selecting the explore control 612 causes a transition from the interaction GUI 202 to a different user experience, such as a web browsing experience.

Thus, techniques for automated agent for content interaction described herein enable users to interact with and explore content, and enable automated interactivity to adjust dynamically when a content context changes.

Having discussed some example implementation scenarios, consider now some example procedures in accordance with one or more implementations.

The following discussion describes some example procedures for sharing across environments in accordance with one or more implementations. The example procedures may be employed in the environment 100 of FIG. 1, the system 900 of FIG. 9, and/or any other suitable environment. The procedures, for instance, represent procedures for implementing the example implementation scenarios discussed above. In at least some implementations, the steps described for the various procedures can be implemented automatically and independent of user interaction. The procedures may be performed locally at the client device 102, by the media service 112, and/or via interaction between the client device 102 and the media service 112. This is not intended to be limiting, however, and aspects of the methods may be performed by any suitable entity.

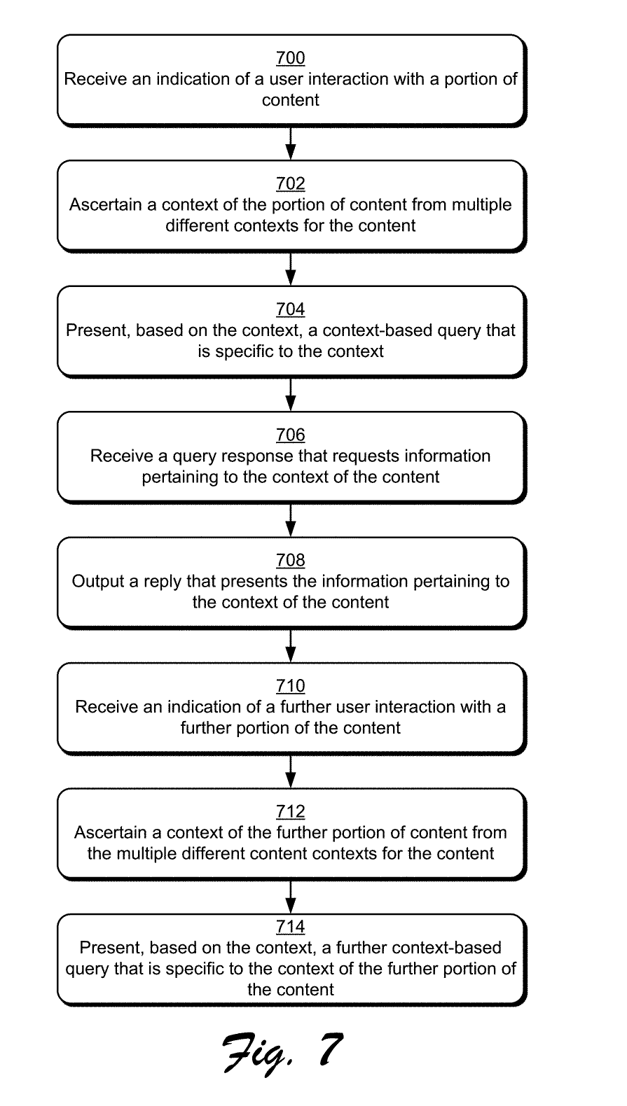

FIG. 7 is a flow diagram that describes steps in a method in accordance with one or more implementations. The method describes an example procedure for enabling interaction with content in accordance with one or more implementations. In at least some implementations, aspects of the method are performed by an automated agent, such as the interaction module 128.

Step 700 receives an indication of a user interaction with a portion of content. The media service 112, for instance, receives an indication that the user 116 interacts with content presented via the media client 106. In at least some implementations, the interaction represents user input to the content, such as gesture input applied to the content.

Step 702 ascertains a context of the portion of content from multiple different contexts for the content. In at least some implementations, this step is performed by an automated agent, such as the interaction module 128.

According to one or more implementations, the multiple different contexts are included as part of content data 124 for the content. For instance, the content data 124 identifies different context information that corresponds to different portions of the content. In at least some implementations, the content data 124 is indexed based on different time values for the content, such as different playback times.

Step 704 presents, based on the context, a context-based query that is specific to the context. The content module 126, for instance, presents a query that prompts the user 116 as to whether the user desires a particular action, such as more information about the content. According to various implementations, the query is directed to a current activity depicted in the content.

Step 706 receives a query response that requests information pertaining to the context of the content. The user 116, for instance, inputs a query response. Generally, the query response can include a request for a particular action and/or information, such as information about subject matter of the content.

Step 708 outputs a reply that presents the information pertaining to the context of the content. The interaction module 128, for instance, outputs information that relates to the context of the content. Examples of such information are discussed throughout, and include biographical information about the content, instructional information for performing an activity, statistical information, historical information, and so forth.

In at least some implementations, a selectable control can be presented with the reply that is selectable to explore additional information about the content and/or perform a certain action pertaining to the content, such as to purchase an item relating to the content.

Step 710 receives an indication of a further user interaction with a further portion of the content. For instance, the content continues playback after the reply referenced above is output by the interaction module 128. The user 116, for instance, initiates playback of the content after the interaction module 128 outputs the reply the includes information about the content.

Step 712 ascertains a context of the further portion of content from the multiple different content contexts for the content. Generally, the context of the further portion of the content is different than the context of the previous portion of the content. The interaction module 128, for example, determines the context of the further portion of content from content data 124 for the content, such as based on a playback time in the content at which the further user interaction occurs. As discussed above, different portions of content data 124 for content can be indexed based on different playback times for the content.

Step 714 presents, based on the context, a further context-based query that is specific to the context of the further portion of the content. The further context-based query, for instance, is determined from the content data 124 for the content, and is specific to a particular activity that is depicted in the content when the further user interaction occurs.

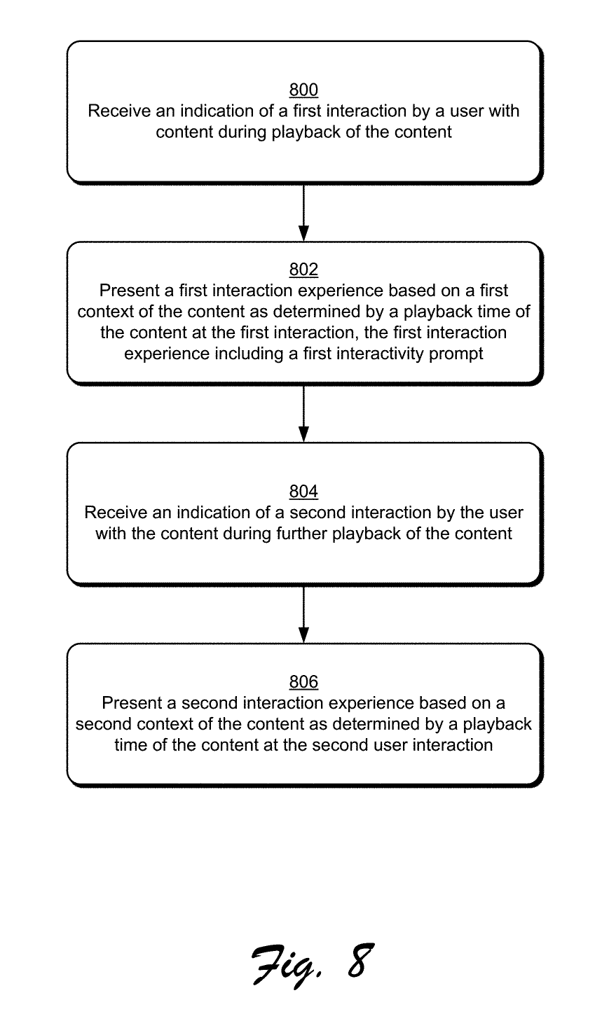

FIG. 8 is a flow diagram that describes steps in a method in accordance with one or more implementations. The method describes an example procedure for enabling interaction with content in accordance with one or more implementations. In at least some implementations, aspects of the method are performed by an automated agent, such as the interaction module 128.

Step 800 receives an indication of a first interaction by a user with content during playback of the content. The interaction module 128, for example, detects that the user 116 provides input to content that is presented by the media service 112 via the media client 106.

Step 802 presents a first interaction experience based on a first context of the content as determined by a playback time of the content at the first interaction, the first interaction experience including a first interactivity prompt. For instance, the interaction module 128 identifies an applicable context by matching a playback time of the content to content data 124 that is indexed for the playback time. The content data, for instance, includes an interactivity prompt (e.g., a context-based query) the prompts the user to determine whether the user wishes to obtain certain information and/or perform a certain action pertaining to the content.

Step 804 receives an indication of a second interaction by the user with the content during further playback of the content. For instance, playback of the content resumes after the first interaction experience, such as in response to user input to resume playback. Thus, the user may provide further input to the content after playback resumes, such as gesture-based input and/or any other suitable input type.

Step 806 presents a second interaction experience based on a second context of the content as determined by a playback time of the content at the second user interaction. Generally, the second context is different than the first context and the second interaction experience presents a second interactivity prompt that is different than the first interactivity prompt. The second interactivity prompt, for instance, prompts the user 116 as to whether the user wishes to perform a certain action and/or obtain additional information pertaining to the second context.

According to various implementations, the methods described above can be implemented as part of a chat session between the interaction module 128 and the user 116. Thus, the various queries, responses, and replies can be output as human-readable words and/or phrases as part of the chat session. Further, content 118 and content data 124 utilized by the methods can be obtained by the media service 112 from the content providers 120.

Thus, techniques for automated agent for content interaction described herein provide context-based interactivity experiences that enable users to view content and to explore the content in various ways. Further, user exploration of content can be tailored based on a context of the content, such as determined by an automated agent (e.g., a bot) that can track context for content and interact with a user based on context.

Having described some example procedures for automated agent for content interaction, consider now a discussion of an example system and device in accordance with one or more implementations.

FIG. 9 illustrates an example system generally at 900 that includes an example computing device 902 that is representative of one or more computing systems and/or devices that may implement various techniques described herein. For example, the client device 102 and/or the media service 112 discussed above with reference to FIG. 1 can be embodied as the computing device 902. The computing device 902 may be, for example, a server of a service provider, a device associated with the client (e.g., a client device), an on-chip system, and/or any other suitable computing device or computing system.

The example computing device 902 as illustrated includes a processing system 904, one or more computer-readable media 906, and one or more Input/Output (I/O) Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 910 and computer-readable media 906 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules that are executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a wearable device, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. For example, functionalities discussed with reference to the client device 102 and/or the media service 112 may be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device implementation, implementation of functionality described herein may be distributed throughout the system 900. For example, the functionality may be implemented in part on the computing device 902 as well as via the platform 922 that abstracts the functionality of the cloud 920.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Techniques for automated agent for content interaction are described. Although implementations are described in language specific to structural features and/or methodological acts, it is to be understood that the implementations defined in the appended claims are not necessarily limited to the specific features or acts described. Rather, the specific features and acts are disclosed as example forms of implementing the claimed implementations.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A system for enabling retrieval and presentation of context-based information for content, the system comprising: one or more processors; and one or more computer-readable storage media storing computer-executable instructions that, responsive to execution by the one or more processors, cause the system to perform operations including: receiving an indication of a user interaction with a portion of content; ascertaining, by an automated agent executed by the one or more processors, a context of the portion of content from multiple different contexts for the content; presenting, based on the context, a context-based query that is specific to the context; receiving a query response that requests information pertaining to the context of the content; and outputting, by the automated agent executed by the one or more processors, a reply that presents the information pertaining to the context of the content.

In addition to any of the above described systems, any one or combination of: wherein the indication of the user interaction comprises an indication of a gesture applied to the content during playback of the portion of the content; wherein the content comprises a video, the multiple different content contexts each correspond to a different portion of the video, and the context is determined based on a playback time of the video at the user interaction with the portion of the content; wherein the content comprises a video and the context is determined based on an activity depicted in the video at the user interaction with the portion of the content; wherein said presenting further comprises presenting a chat experience that enables a user to chat with the automated agent regarding the content, the chat experience including the query as a human-readable phrase pertaining to the context of the portion of the content; wherein the automated agent is executed at a media service remote from a content provider that provides the content; wherein the automated agent is executed at a media service remote from a content provider that provides the content, and wherein the context-based query is retrieved from content data retrieved from the content provider; wherein the context-based query is retrieved from content data for the content, the content data including multiple different context-based queries that each apply to a different context of the multiple different contexts for the content; wherein the reply further includes a selectable control that is selectable to cause execution of an action relating to the context of the content; wherein the operations further include: receiving an indication of a further user interaction with a further portion of the content; ascertaining, by the automated agent executed by the one or more processors, a context of the further portion of content from the multiple different content contexts for the content, the context of the further portion of the content being different than the context of the portion of the content; and presenting, based on the context, a further context-based query that is specific to the context of the further portion of the content.

A method for enabling retrieval and presentation of context-based information for content, the method comprising: receiving an indication of a first interaction by a user with content during playback of the content; presenting, by an automated agent executed by one or more processors, a first interaction experience based on a first context of the content as determined by a playback time of the content at the first interaction, the first interaction experience including a first interactivity prompt; receiving an indication of a second interaction by the user with the content during further playback of the content; and presenting, by the automated agent executed by the one or more processors, a second interaction experience based on a second context of the content as determined by a playback time of the content at the second user interaction, the second context being different than the first context and the second interaction experience presenting a second interactivity prompt that is different than the first interactivity prompt.

In addition to any of the above described systems, any one or combination of: wherein the first context and the second context are determined from a set of contexts that are specific to the content, at least some of the contexts being specific to different respective playback times of the content; wherein the first context and the second context are determined from a set of contexts that are specific to the content, the set of contexts being obtained by the automated agent from a content provider that provides the content; wherein the first interaction experience causes a pause in playback of the content, and wherein the second user interaction with the content occurs after playback of the content is resumed after the first interaction experience; wherein one or more of the first interaction experience or the second interaction experience comprises a chat session between a user and the automated agent; wherein the first context and the second context are determined from content data for the content, and wherein different portions of the content data are indexed based on different playback times for the content; wherein the content depicts a particular activity, and wherein one or more of the first interaction experience or the second interaction experience comprises a selectable control that is selectable to initiate a purchase of an item associated with the particular activity.

A method for enabling retrieval and presentation of context-based information for content, the method comprising: ascertaining, by an automated agent executed by the one or more processors and responsive to a user interaction with content, a current context of the content from multiple different content contexts; presenting, based on the current context, a context-based query that is specific to the current context; receiving a query response that requests information pertaining to the current context of the content; and outputting, by the automated agent executed by the one or more processors, a reply that presents the information pertaining to the current context of the content and that includes a selectable control that is selectable to cause an action relating to the content to be performed.

In addition to any of the above described methods, any one or combination of: wherein said ascertaining comprises determining the current context based on a playback time of the content at the user interaction with the content; wherein the content depicts a particular activity, and wherein the action relating to the content comprises one or more of obtaining information about the activity, or purchasing an item relating to the activity.

What is claimed is:

1. A system comprising:
one or more processors; and
one or more computer-readable storage media storing computer-executable instructions that, responsive to execution by the one or more processors, cause the system to perform operations including:
receiving an indication of a user interaction with a portion of content;
ascertaining, by an automated agent executed by the one or more processors, a context of the portion of content from multiple different contexts for the content;
presenting, based on the context, a context-based query that is specific to the context;
receiving a query response that requests information pertaining to the context of the content; and
outputting, by the automated agent executed by the one or more processors, a reply that presents the information pertaining to the context of the content.

2. The system as described in claim 1, wherein the indication of the user interaction comprises an indication of a gesture applied to the content during playback of the portion of the content.

3. The system as described in claim 1, wherein the content comprises a video, the multiple different content contexts each correspond to a different portion of the video, and the context is determined based on a playback time of the video at the user interaction with the portion of the content.

4. The system as described in claim 1, wherein the content comprises a video and the context is determined based on an activity depicted in the video at the user interaction with the portion of the content.

5. The system as described in claim 1, wherein said presenting further comprises presenting a chat experience that enables a user to chat with the automated agent regarding the content, the chat experience including the query as a human-readable phrase pertaining to the context of the portion of the content.

6. The system as described in claim 1, wherein the automated agent is executed at a media service remote from a content provider that provides the content.

7. The system as described in claim 1, wherein the automated agent is executed at a media service remote from a content provider that provides the content, and wherein the context-based query is retrieved from content data retrieved from the content provider.

8. The system as described in claim 1, wherein the context-based query is retrieved from content data for the content, the content data including multiple different context-based queries that each apply to a different context of the multiple different contexts for the content.

9. The system as described in claim 1, wherein the reply further includes a selectable control that is selectable to cause execution of an action relating to the context of the content.

10. The system as described in claim 1, wherein the operations further include:
receiving an indication of a further user interaction with a further portion of the content;
ascertaining, by the automated agent executed by the one or more processors, a context of the further portion of content from the multiple different content contexts for the content, the context of the further portion of the content being different than the context of the portion of the content; and
presenting, based on the context, a further context-based query that is specific to the context of the further portion of the content.

11. A method comprising:
receiving an indication of a first interaction by a user with content during playback of the content;
presenting, by an automated agent executed by one or more processors, a first interaction experience based on a first context of the content as determined by a playback time of the content at the first interaction, the first interaction experience including a first interactivity prompt;
receiving an indication of a second interaction by the user with the content during further playback of the content; and
presenting, by the automated agent executed by the one or more processors, a second interaction experience based on a second context of the content as determined by a playback time of the content at the second user interaction, the second context being different than the first context and the second interaction experience presenting a second interactivity prompt that is different than the first interactivity prompt.

12. The method as described in claim 11, wherein the first context and the second context are determined from a set of contexts that are specific to the content, at least some of the contexts being specific to different respective playback times of the content.

13. The method as described in claim 11, wherein the first context and the second context are determined from a set of contexts that are specific to the content, the set of contexts being obtained by the automated agent from a content provider that provides the content.

14. The method as described in claim 11, wherein the first interaction experience causes a pause in playback of the content, and wherein the second user interaction with the content occurs after playback of the content is resumed after the first interaction experience.

15. The method as described in claim 11, wherein one or more of the first interaction experience or the second interaction experience comprises a chat session between a user and the automated agent.

16. The method as described in claim 11, wherein the first context and the second context are determined from content data for the content, and wherein different portions of the content data are indexed based on different playback times for the content.

17. The method as described in claim 11, wherein the content depicts a particular activity, and wherein one or more of the first interaction experience or the second interaction experience comprises a selectable control that is selectable to initiate a purchase of an item associated with the particular activity.

18. A method comprising:
ascertaining, by an automated agent executed by the one or more processors and responsive to a user interaction with content, a current context of the content from multiple different content contexts;
presenting, based on the current context, a context-based query that is specific to the current context;
receiving a query response that requests information pertaining to the current context of the content; and
outputting, by the automated agent executed by the one or more processors, a reply that presents the information pertaining to the current context of the content and that includes a selectable control that is selectable to cause an action relating to the content to be performed.

19. The method as described in claim 18, wherein said ascertaining comprises determining the current context based on a playback time of the content at the user interaction with the content.

20. The method as described in claim 18, wherein the content depicts a particular activity, and wherein the action relating to the content comprises one or more of obtaining information about the activity, or purchasing an item relating to the activity.
